(19) United States
(12) Patent Application Publication
(10) Pub. No.: US 2016/0239859 A1
(43) Pub. Date: Aug. 18, 2016

(54) REPRESENTATION AND DISSEMINATION OF USER PREFERENCES

(71) Applicant: MasterCard Asia/Pacific Pte. Ltd., Singapore (SG)

(72) Inventor: Philip Weiping YEN, Singapore (SG)

(21) Appl. No.: 15/018,479

(22) Filed: Feb. 8, 2016

(30) Foreign Application Priority Data
Feb. 17, 2015 (SG) 10201501240W

(51) Int. Cl. G06Q 30/02; G06Q 30/06

(52) U.S. Cl. CPC G06Q 30/0207; G06Q 30/0601

(57) ABSTRACT

A method for disseminating user preference data, the method comprising: determining a user preference representation, wherein the user preference representation is configured to represent user preference data of a user towards any one or more of promotions, purchases and payment; and disseminating the user preference representation to a plurality of recipients, wherein the plurality of recipients processes the user preference representation to recover the user preference data of the user, to regulate delivery of content to the user.

### CROSS-REFERENCE TO RELATED APPLICATION

This application is a U.S. National Stage filing under 35 U.S.C. §119, based on and claiming benefit of and priority to SG Patent Application No. 10201501240W filed Feb. 17, 2015.

### FIELD OF THE INVENTION

The following discloses arrangements for representation and dissemination of user preferences.

### BACKGROUND

In a digital ecosystem, users have unique preferences based on lifestyle and social needs. Some users hold online privacy in high regard, and take measures possible to minimize their online presences. Conversely, some users are open to maximizing their online presence.

A user can set his/her privacy settings, at a content provider's website, to customize the type of content, and the frequency that the content is delivered to the user. Online marketing and advertising agencies, electronic commerce (e-commerce), and social media websites utilize these user preferences to increase the relevance and receptivity of the content delivered to the user.

To maintain the same level of privacy across multiple websites a user repeats the process of setting his/her user preferences at another content provider's website from which the user wishes to receive content. Content providers to whom the user has not indicated his/her user preferences delivers information or advertisements that are irrelevant to the user, or too frequently. This causes the user to have a negative impression of the new content provider. If a user wants to modify the user preferences, he/she would have to approach each of the plurality of content providers to modify the settings, which is a highly inefficient process.

Thus, there is a want for a simple and robust method for the representation and dissemination of user preferences. Furthermore, other desirable features and characteristics will become apparent from the subsequent detailed description and the appended claims, taken in conjunction with the accompanying drawings and this background of the disclosure.

### SUMMARY

In a first aspect of the present invention, a method for disseminating user preference data is disclosed, the method comprising: determining a user preference representation, wherein the user preference representation is configured to represent user preference data of a user towards any one or more of promotions, purchases and payment; and disseminating the user preference representation to a plurality of recipients, wherein the plurality of recipients processes the user preference representation to recover the user preference data of the user, to regulate delivery of content to the user.

In a second aspect of the present invention, a server for disseminating user preference data is disclosed, the server comprising: at least one processor; and at least one memory including computer program code; the at least one memory and the computer program code configured to, with the at least one processor, cause the server at least to: determine a user preference representation in response to user preference data received by the server, wherein the user preference representation is configured to represent user preference data of a user towards any one or more of promotions, purchases and payment; and disseminate the user preference representation to a plurality of recipients, wherein the plurality of recipients processes the user preference representation to recover the user preference data of the user, to regulate delivery of content to the user.

In a third aspect of the present invention, a computer readable storage medium having a computer program recorded therein is disclosed, the program being executable by a computer apparatus to configure the computer apparatus at least to: determine a user preference representation, wherein the user preference representation is configured to represent user preference data of a user towards any one or more of promotions, purchases and payment; and disseminate the user preference representation to a plurality of recipients, wherein the plurality of recipients processes the user preference representation to recover the user preference data of the user, to regulate delivery of content to the user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 depicts a flowchart of a method embodying representation and dissemination of user preference data.

FIG. 2 depicts a database embodying user preference data.

FIG. 3 depicts a block diagram embodying a network for representation and dissemination of user preference data.

FIG. 4 depicts an exemplary computing device, to realize a server for the network shown in FIG. 3.

FIG. 5 depicts an embodiment exemplifying a network of users (consumers) and recipients in communication with a database in which user (consumer) preference data is stored.

FIG. 6 depicts an embodiment exemplifying how information is accessed from the database.

FIG. 7 depicts an embodiment exemplifying how the database is updated.

FIG. 8 depicts an embodiment exemplifying how consumer preference data is transmitted to the consumer preference database in a network.

FIG. 9 depicts an embodiment exemplifying how consumer preference data is utilized during an online web transaction.

And FIG. 10 depicts an embodiment exemplifying how consumer preference data is utilized during an in-store transaction.

Skilled artisans will appreciate that elements in the figures are illustrated for simplicity and clarity and have not necessarily been depicted to scale. For example, the dimensions of some of the elements in the block diagrams or steps in the flowcharts may be exaggerated in respect to other elements to help improve understanding of the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to disclose an improved system to facilitate representation and dissemination of user preference data.

As more user devices and software platforms are enabled for electronic commerce (e-commerce), content delivery agents are increasing consumer engagement through omni-channel connections with consumers, thereby facilitating omni-channel retailing. Omni-channel retailing allows merchants to engage with the customers via multiple avenues, including the physical store, online access, or other channels. In this context, omni-channel retailing provides a more efficient means to engage customers in a more personal manner, and provide offers that are relative to a specific consumer determined by purchase patterns, social network affinities, website visits, and loyalty programs that the consumer is enrolled in. Currently, such information on consumer behaviour is collected by individual merchants, and sharing of this information is sluggish.

Generally, consumers do not want notifications, alerts, and other communications that are overly intrusive and/or irrelevant. Content delivery agents may adapt to this by customizing the content based on what is in fashion at the moment. However, broad changes to content delivery based on current trends do not cater to the needs of individual customers. In addition to varying preferences regarding content, the individual consumer would have preferences regarding privacy, transaction, and security preferences. These varying preferences across individual consumers would not be addressed on a broad scale. For example, some customers may have different privacy expectations and do not want notifications, alerts, and other communications that they feel are overly intrusive. Alternatively, some consumers are open to receive information and promotions, but only if they are relevant to their interests. Additionally, some consumers may have a preference towards transaction processes with robust security authentication, while some prefer ease of use and convenience. The individuality of consumers makes content delivery a convoluted process for the content delivery agents.

Accordingly, there is a need to improve the delivery of information between the content delivery agents and users (e.g. customers, consumers) in this omni-channel eco-system. There exists a need to address three main areas of concern, namely, what, how, and when information is provided to the consumers.

The embodiments in the present invention seek to address the above challenges by disclosing means to represent and disseminate user preferences such as preferences for privacy, transaction, content, and security. Further, the embodiments in the present invention disclose a system where stakeholders of the omni-channel eco-system are able to contribute and utilize the database of user preference representations. The system may be administered by a central control, such as a payment network, national association, standards body or a government agency, where rules may be enforced, to ensure interoperable implementations and a uniform experience for consumers.

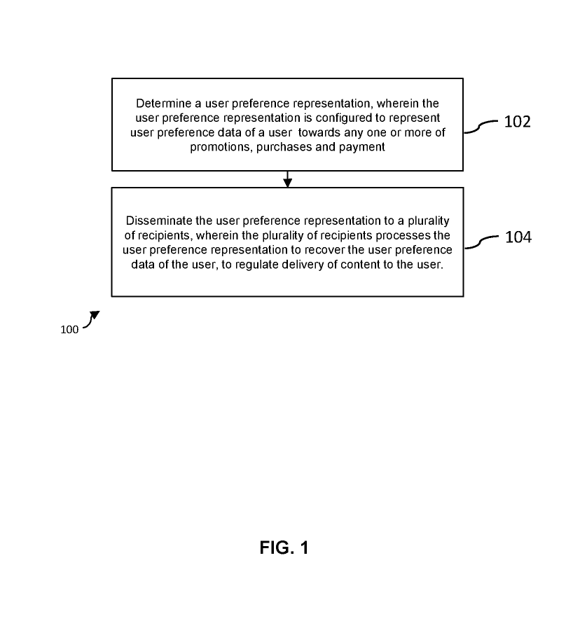

FIG. 1 depicts a flowchart 100 of a method embodying representation and dissemination of user preference data in accordance with a present embodiment. In step 102, a user preference representation is determined for a user, wherein the user preference representation is configured to represent user preference data of a user towards any one or more of promotions, purchases and payment. In one implementation, promotions refer to content that advertises the launch of a new good or service that belong to a classification that holds the user's interest or a discount being provided on goods or services that the user has a purchase history. Purchases may refer to a record of goods or services that the user has bought, along with a classification under which these goods or services fall. Payment may refer to a record of the medium used to make payment for goods or services, which includes any one or more of cash, a pre-paid card, credit or debit cards and mobile devices having stored thereon payment card data, or other details representing card data. In step 104, the user preference representation is disseminated to a plurality of recipients, wherein the plurality of recipients processes the user preference representation to recover the user preference data of the user, to regulate delivery of content, from the plurality of recipients of the user preference representation, to the user.

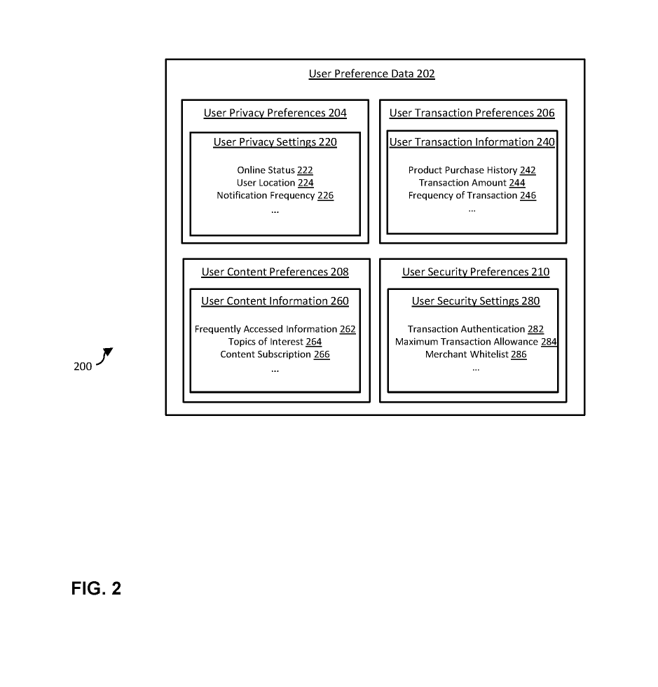

FIG. 2 depicts a database 200 that stores user preference data 202. The user preference data 202 is derived from data related to the user. Additionally, the user preference data 202 also includes database records or input by users. The user preference data 202 comprises data indicative of, or derived from, any one or more of user privacy preferences 204, user transaction preferences 206, user content preferences 208 and user security preferences 210. Although not shown, the user preference data 202 may be purchase data and payment preferences of the user.

In the present embodiment, the user privacy preferences 204 comprise user privacy settings 220, including any one or more of user online status 222, user location 224 and notification frequency 226. Preferably, the user online status 222 comprises: (a) online; (b) user offline, or (c) time user was last seen. Preferably, the user location 224 comprises the longitude and latitude of the user's current or past location. Preferably, the notification frequency comprises: (a) allow all push notifications or (b) do not allow push notifications. In the present embodiment, the user transaction preferences 206 comprises user transaction information 240 including any one or more of product purchase history 242, transaction amount 244 and frequency of transaction 246. Preferably, the product purchase history 242 comprises a log of transaction history or types of brands purchased. Preferably, the transaction amount 244 comprises the number of purchases over a certain amount. Preferably, the frequency of transaction 246 comprises the number of transactions over the last 30 days. In the present embodiment, the user content preferences 208 comprises user content information 260 including any one or more of frequently accessed information 262, topics of interest 264 and content subscription 266. Preferably, the frequently accessed information 262 comprises the number of times a user had accessed brand X's webpage. Preferably, the topics of interest 264 comprises user selected preference for X brand handbags. Preferably, the content subscription 266 comprises the promotional mailing lists that a user has subscribed to receive promotional information about brand X. In the present embodiment, the user security preferences 210 comprises user security settings 280 including any one or more of transaction authentication 282, maximum transaction allowance 284 and merchant whitelist 286. Preferably, the transaction authentication 282 comprises user preference for high security transaction authentication. Preferably, the maximum transaction allowance 284 comprises a user selected option to allow all purchases below a predetermined amount, for example, $200 with basic authentication. Preferably, the merchant whitelist 286 comprises a list of trusted merchants that the user frequently engages for transactions.

In an embodiment, a user preference representation is assigned to represent the user preference data 202 including user privacy preferences 204, user transaction preferences 206, user content preferences 208 and user security preferences 210. In an embodiment, the user preference representation is a message comprising any one or more of numbers, text or symbols. Preferably, the user preference representation is an adaptive message that changes as any one or more of the user preference data 202 changes. Alternatively, the user preference representation is a static message that remains constant as any one or more of the user preference data 202 changes.

In an embodiment, the user preference representation is configured by the user. As many users may not want, or do not understand enough, to spend much time in setting their preferences, a simple scale may be the basic level of user preference representation. The user, for example, is able to set his/her user privacy preferences 204 to a “High”, a “Medium”, or a “Low” setting. A similar approach may be applied for user transaction preferences 206, and user security preferences 210. For user content preferences 208, the basic representation could be 3 or 4 categories such as (a) send all offers; (b) send offers only for merchandise that are specifically requested; (c) do not send any offers.

For sophisticated users, more options are provided to further qualify their user preferences. In an embodiment, the user content preferences 208 includes options such as: “Only provide me with promotions for travel, dining, and entertainment”. In the present embodiment, the user security preferences 210 include options such as: “Necessitate a high security authentication procedure when purchases exceed $50,000, but allow simple authentication procedures when the purchase is below $10 for convenience”. Further, in the present embodiment, the user privacy settings 220 includes options such as: “Provide me with e-mail notifications only from merchants from whom I previously made a purchase”. The user preference representation advantageously provides a simple and efficient means to represent the multitude of user preferences for a user.

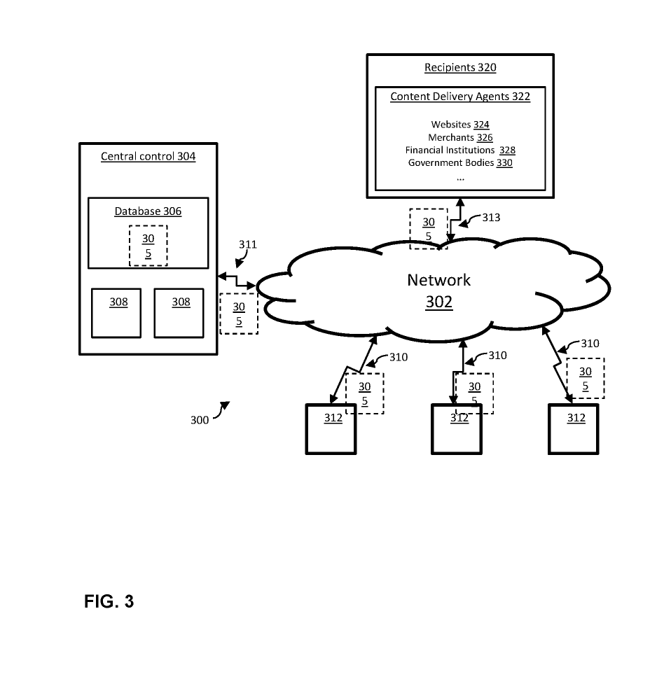

FIG. 3 depicts a block diagram 300 embodying a network 302 for representation and dissemination of user preference data 202. A central control (e.g. a server) 304 comprising a database 306, and staff access terminals 308, is coupled to the network 302 via a coupling 311, the coupling 311 comprising a wired and/or wireless coupling. A plurality of user terminals 312 are each coupled to the network 302 via a coupling 310, the coupling 310 comprising a wired and/or wireless coupling. The central control 304 determines a user preference representation (depicted as data packet 305) for each of the plurality of users 312 in response to user preference data received by the central control 304, wherein the user preference representation 305 is configured to represent user preference data of a user 312 towards any one or more of promotions, purchases and payment. The central control 304 stores the user preference representation 305 into the database 306 for future access.

In the present embodiment, a plurality of recipients 320 is also coupled to the network 302 via a coupling 313, the coupling 313 comprising a wired or wireless coupling. The plurality of recipients 320 comprises content delivery agents 322 including any one or more of websites 324, merchants 326, financial institutions 328 and government bodies 330.

The central control 304 operates to disseminate the user preference representation 305 of a user 312 or of a plurality of users to the plurality of recipients 320. The plurality of recipients 320 processes the user preference representation 305 to recover the user preference data of the user 312, to regulate delivery of content to the user 312 by delivering content in compliance with the user preference data of the user 312. The central control 304 provides the user preference representation 305 to the user 312 for approval before dissemination, in a format providing sufficient descriptive detail about the user preference representation.

In an embodiment, the user preference data 305 is managed by the central control 304. The central control 304 comprises any one or more of a payment network, national association, standards body and a government agency, where certain rules can be enforced, to ensure interoperable implementations and uniform experience for the users 312. The central control 304 is configured to assign a default user preference representation 305 for the user 312, in the absence of explicit user input. In an embodiment, the user preference representation 305 is based on the user preference data 305 of the user, such as known user choices in adjacent environments (e.g. internet banking) or history of prior purchases. In an embodiment, the user preference data 305 is automatically configured as a “medium setting” in the absence of explicit user input (e.g. medium security, medium privacy, and promotions from merchants of previous purchases). This advantageously provides a simple and robust means to represent user preference data.

In a further embodiment, the central control 304 establishes a repository where the plurality of recipients 320 participates in contribution and utilization of user preference representations of a plurality of users 312. The central control 304 provides methods for the plurality of recipients 320 and users 312 to input and update user preference representations or user preference data into the repository, or to validate user preference representations assigned by the central control 304. In other embodiments, the central control 304 provides secure storage and secure access to the database 306 of user preference representations for the plurality of recipients 320 and users 312. Further, the central control 304 maintains and updates the stored user preference representations to keep the database 306 current. In the central control 304 an interface is provided to allow for the plurality of recipients 320 and users 312 to request for user preference representations. These requests are approved or rejected if a criteria of the request does not comply with a criteria predetermined by the repository. The repository advantageously provides a central means to consolidate all user preference data of the user 312. If the user 312 wishes to change his/her user preference data, it can be performed through the repository, which advantageously removes the need for the user 312 to approach each of the plurality of content delivery agents 322.

The central control 304 may provide the user preference representation 305 as a message comprising text or numbers representative of the user preference data. The user preference representation 305 may be adjusted based on context and environment of the origination of request. In an embodiment, the user preference representation 305 is also adjusted based on dynamic connection to other user preference databases and/or an alternate user preference representation system. In an embodiment, the user preference representations 305 are actual preferences instead of a numerical value. The central control 304 incorporates the results into its own product and service offerings. An adaptive user representation is advantageous as the plurality of recipients may adapt to any changes in the user preference data quickly.

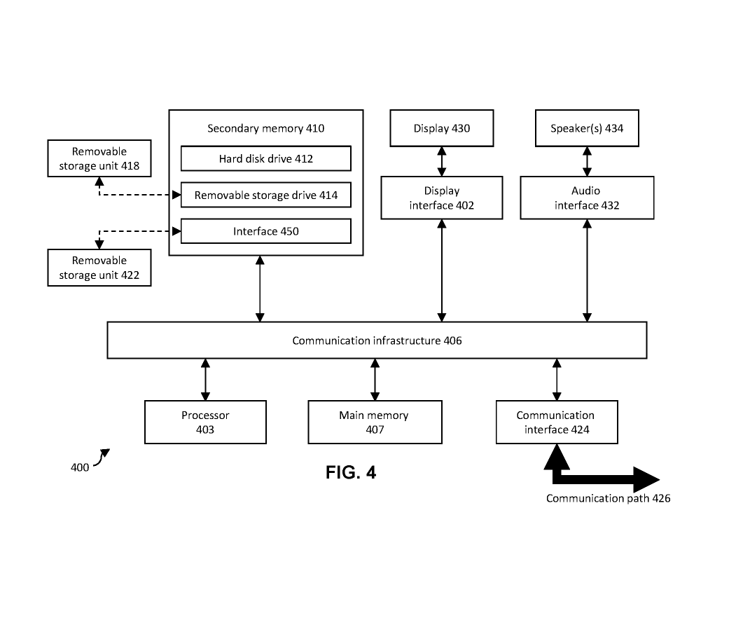

FIG. 4 shows an exemplary computing device 400 for one or more systems coupled to the network 302 shown in FIG. 3. The computing device 400 may be the user's access terminal 312 (e.g. mobile device or desktop), the server of the central control 304, or the plurality of recipient's 302 computer terminals coupled to the network 302. The following description of the computing device 400 is provided by way of example only and is not intended to be limiting. Therefore, one or more elements/components of the computing device 400 may be omitted. Also, one or more elements/components of the computing device 400 may be combined together. Additionally, one or more elements/components of the computing device 400 may be split into one or more component parts.

With reference to FIG. 4, the exemplary computing device 400 includes a processor 403 for executing software routines. Although a single processor is shown for the sake of clarity, the computing device 400 may also include a multi-processor system. The processor 403 is connected to a communication infrastructure 406 for communication with other components of the computing device 400. The communication infrastructure 406 may include, for example, a communications bus, cross-bar, or network.

The computing device 400 further includes a main memory 407, such as a Random Access Memory (RAM), and a secondary memory 410. The secondary memory 410 may include, for example, a hard disk drive 412 and/or a removable storage drive 414, which may include a floppy disk drive, a magnetic tape drive, an optical disk drive, or the like. The removable storage drive 414 reads from and/or writes to a removable storage unit 418 in a well-known manner. The removable storage unit 418 may include a floppy disk, magnetic tape, optical disk, or the like, which is read by and written to by removable storage drive 414. As will be appreciated by persons skilled in the relevant art(s), the removable storage unit 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 450. Examples of a removable storage unit 422 and interface 450 include a program cartridge and cartridge interface (such as that found in video game console devices), a removable memory chip (such as an EPROM or PROM) and associated socket, and other removable storage units 422 and interfaces 450 which allow software and data to be transferred from the removable storage unit 422 to the computing device 400.

The computing device 400 also includes at least one communication interface 424. The communication interface 424 allows software and data to be transferred between computing device 400 and external devices via a communication path 426. In various implementations, the communication interface 424 permits data to be transferred between the computing device 400 and a data communication network 302, such as a public data or private data communication network. The communication interface 424 may be used to exchange data between different computing devices 400 which such computing devices 400 form part an interconnected computer network 302. Examples of a communication interface 424 can include a modem, a network interface (such as an Ethernet card), a communication port, an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. A computer readable medium can include magnetic media, optical media, or other recordable media, or media that transmits a carrier wave or other signal. These computer program products are devices for providing software to the computing device 400. Computer readable storage medium refers to any non-transitory tangible storage medium that provides recorded instructions and/or data to the computing device 400 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called “computer program code”) are stored in main memory 407 and/or secondary memory 410. Computer programs can also be received via the communication interface 424. Such computer programs, when executed, enable the computing device 400 to perform one or more method steps of the example embodiment. Accordingly, such computer programs may represent controllers of the computing device 400.

Software may be stored in a computer program product and loaded into the computing device 400 using the removable storage drive 414, the hard disk drive 412, or the interface 450. Alternatively, the computer program product may be downloaded to the computing device 400 over the communications path 426. The software, when executed by the processor 403, causes the computing device 400 to perform the necessary operations to execute the method steps as shown in FIG. 1.

Referring to both FIGS. 3 and 4, for example, users 312 are invited to utilize a repository provided by the central control 304. Users 312 utilize the repository via a website, or through their computing device 400, accessing a Uniform Resource Locator (URL), scanning a Quick Response Code (QR Code), or via social media. Users will be required to authenticate themselves to gain access, such as providing biometrics, passwords, or other via authentication methods. Users 312 are asked to input user preference data related to user privacy preferences (how often, where, when notifications, solicitations, promotions, alerts can be made to the computing device 400), and user content preferences (what type of merchandise or deals that will be relevant). Users are offered default settings for user transaction preferences based on prior purchase history or prior promotion redemption history. In an embodiment, users are offered default settings for user security preferences, based on known use of security and privacy mechanisms such as (Personal Identification Number) PIN or an online three-domain authentication program. In an embodiment, the user utilizes the repository through any one of the participating content delivery agents 322.

In an embodiment, the user is offered a selection of user content preferences regarding promotional content. Examples of default content preferences include: fixed amount discount for overall purchase, fixed amount discount for specific merchandise, percentage discount for overall purchase, percentage discount for specific merchandise, volume purchase discounts (e.g. buy 2 get 1 free), fixed amount or percentage of purchase to be credited to the user's account directly, credit of fixed amount or percentage of purchase to be used for future purchase. The selection of user content preferences is activated by the user when using a digital wallet.

In an embodiment, to utilize the repository provided by the central control 304, users 312 download a mobile application from the central control 304, or from other content delivery agents 322, into their computing device 400. Upon physical entry into a participating merchant's 326 premises with the computing device 400, the user 312 checks-in through Bluetooth Low Energy (BLE) connection or via mobile browser connection to the repository. Check-in could be triggered by Point of sale (POS) system detecting the presence of the computing device 400, and prompting the application to invite user 312 to check in. Check-in can also be initiated by user 312 directly selecting the repository's mobile application on the computing device 400 and performing a non-prompted check-in. After check-in, the participating merchant 326 and/or the application initiates a request to the central control 304 to obtain the user's 312 user preference representation. Such request contains identification and authentication data. Upon authenticating the request, the central control 304 returns a response to the participating merchant 326. Based on the user preference representation 305 received, the participating merchant 326 tailors the type of promotions delivered to the user 312 in accordance with the user's privacy preferences. For example, a bigger discount is provided if the user 312 will share purchases with friends via social media (e.g. “likes”), and rewards are provided to the user 312 if other users are referred to utilize the repository.

In an embodiment, the central control 304 and the content delivery agents 322 regulates the delivery of content to an individual user 312 by tailoring the transaction experience to user 312 based on the user preference representation 305 of the user 312. With reference to FIGS. 2, 3 and 4, the user preference representation 305 is processed to retrieve user privacy preferences 204, user transaction preferences 206, user content preferences 208 and user security preferences 210 of the user 312. Based on the user content preferences 204, the content delivery agents 322 provides alerts and notifications to the user's computing device 400 about a purchase that the user 312 is undertaking, or customize the level of transaction authentication required for the purchase, based on the user's security preferences 210 (e.g. PIN, M-PIN or 2^{nd} factor authentication). Based on the user's privacy preferences 204, the user's location or access means (e.g. Access from a home desktop, internet cafe, or computing device 400) could be used to customize the security required for the transaction. For example, the degree of security authentication is elevated if the user 312 undertakes the transaction from a new computing device 400, an overseas location, or when the user undertakes a transaction in which the transaction amount exceeds that of the user's usual expenditure.

In the embodiment of FIG. 3, the central control 304 and the content delivery agents 322 regulates the delivery of content to an individual user 312 by providing related information such as promotions, interests, similar products available from other content delivery agents 322 and product reviews, which are of interest to the user 312, based on the user preference representation 305 of the user 312.

In an embodiment, the central control 304 and the content delivery agents 322 provides a payment vehicle e.g. a digital wallet, for the users 312. A mobile application integrates with the digital wallet for purchases through the mobile application. In this embodiment, the mobile application is downloaded and installed on a user's mobile phone to facilitate the delivery of content based on the user preference representation 305 of the user 312. Products which are of interest to the user 312 are recommended to the user 312 for purchase when the user 312 is in the vicinity of the merchant 326. Such purchases are conducted via Near Field Communication (NFC), QR Code, BLE, or through direct mobile browser connection. In various embodiments, the digital wallet is integrated with the user preference representation 305 such that the user's transaction preferences 206 are selected automatically based on the user preference representation 305. For example, if the user preference representation 305 allows for low security, high convenience transactions, a promotion is redeemed together with payment in a single interaction between mobile and POS via NFC, QR Code, or BLE, without requiring PIN authentication by the user 312.

The central control 304 and the content delivery agents 322 deliver content such as relevant offers or product information through a POS device of the merchants 326. The user 312 is provided the option to purchase additional items when checking out at the POS device. If the user preference representation 305 allows for delivery of related content, the POS device displays other items related to the purchase. For example, a product insurance plan is offered when the user 312 is purchasing an expensive electronic device. The POS device displays items that the user 312 had previously purchased to allow the user to repeat the purchase conveniently. The POS device invites users 312 to use a particular payment instrument from a content delivery agent 322, or perform a self check-out via the repository's mobile application or POS device.

In an embodiment, the POS device receives user preference representation 305 from the user's mobile phone via NFC, QR Code, or BLE, and subsequently suggests a preferred mode of payment to the user 312, such as preferred credit card, preferred debit or preferred EMV chip card. Alternatively, the POS device receives user preference representation 305 from a cloud-based transaction service such as an electronic wallet installed in the user's mobile device. In an alternative embodiment, the electronic wallet is a transaction management service provided by the central control 304 or any of the content delivery agents 322 connected to the network 302. The POS device transmits details of the transaction to the central control 304 for verification with the participating merchants 326 in order to approve the transaction.

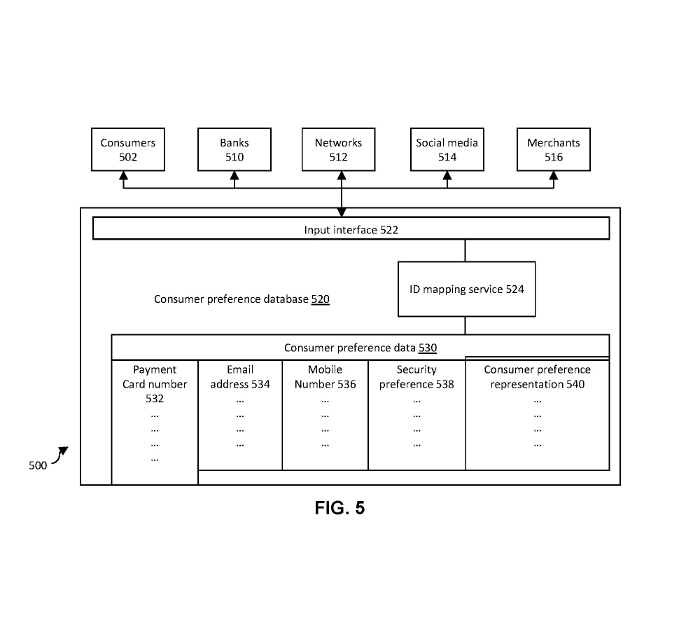

FIG. 5 shows an exemplary network 500 of users (e.g. consumers) 502 and a plurality of recipients 510, 512, 514, 516 in communication with a database 520 in which user (e.g. consumer) preference data 530 are stored. In the present embodiment, the consumers are able to store their consumer preference data 530 in the consumer preference database 520 through a web based input interface module 522 of the consumer preference database 520. In an embodiment, the consumer preference data 530 comprises the consumer's payment card number 532, email address 534, mobile number 536, and security preference 538. Banks 510, networks 512 (e.g. financial institutions, government bodies and internet service providers), social media sites 514, and merchants 516 contribute to the consumer preference database 520 by depositing consumer preference data 530 which they have collected into the consumer preference database 520. This advantageously provides a centralized location to store and manage consumer preference data 530 that the banks 510, networks 512, social media sites 514, and merchants 516 have collected.

In an embodiment, any one or more banks 510, networks 512, social media sites 514, and merchants 516 are able to request for consumer preference data 530 though the input interface module 522. To protect the privacy of the consumer, the consumer preference data 530 within the consumer preference database 530 is mapped to a consumer preference representation 540 by an ID mapping service module 524 that is in communication with the consumer preference database 520. This advantageously provides a convenient means to represent the consumer preference data 532, 534, 536, 538 of a consumer 502. In an embodiment, the consumer preference representation 540 is devoid of information that can identify the consumer. This advantageously allows for the consumer preference representation 540 to be disseminated to the plurality of recipients 510, 512, 514, 516 for use in market trend analysis without revealing the identity of the consumers. Furthermore, a centralized consumer preference database 520 provides an advantageous means of obtaining large data sets of consumer preference data 530, particularly useful when conducting market trend analysis.

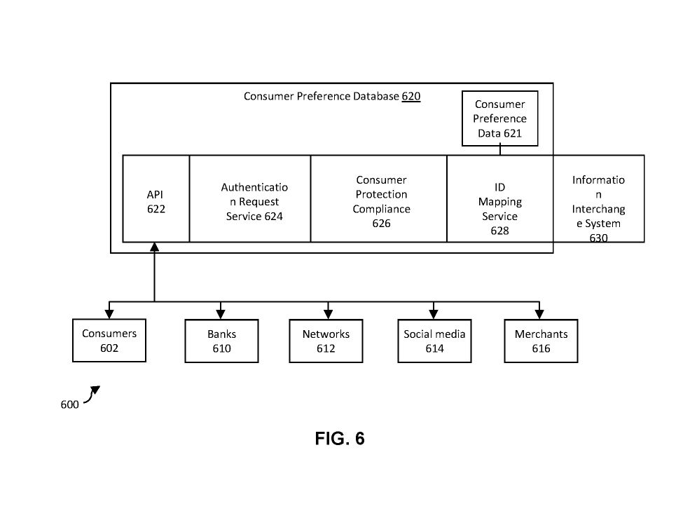

FIG. 6 depicts an alternative embodiment of a network 600 comprising users (e.g. consumers) 602 and recipients (i.e. requestors) 610, 612, 614, 616 in communication with a consumer preference database 620 in which user (e.g. consumer) preference data 621 are stored. Consumers 602, banks 610, networks 612, social media sites 614, and merchants 616 deposit consumer preference data 621 into the consumer preference database 620 by accessing the consumer preference database 620 using the Application Programming Interface (API) 622 of the consumer preference database 620.

In an embodiment, the deposited consumer preference data 621 is mapped to a consumer (i.e. user) preference representation (not shown) by an ID mapping service module 628, to separate the personal particulars of the consumers from the consumer preference representation.

In the present embodiment, banks 610, networks 612, social media 614, and merchants 616 request for consumer preference data 621 though the API 622 of the consumer preference database 620. The request is validated by the authentication request service module 624 to determine if the requestor 610, 612, 614 or 616 is contractually eligible to access the consumer preference database 620. The request is further validated against a predetermined set of requirements by the consumer protection compliance module 626, whereby compliance with data privacy rules of the country, intended use of the consumer preference data 621. Local regulations in relation to dissemination of consumer preference data 621 are also checked by the consumer protection compliance module 626.

In an alternative embodiment, the consumer preference database 620 further comprises an information interchange system module 630 which monitors information being transferred in the network 600. The information interchange system module 630 advantageously provides authorization and monetary settlement for the deposit, transfer, exchange, and requests of consumer preference data 621 in the network 600. In an embodiment, the information interchange system module 630 manages monetary settlement between the administrator of the consumer preference database 620 and the merchants 616, for example, when the merchants 616 contribute to the consumer preference database 620 by depositing consumer preference data 621 into the consumer preference database 620. In an alternative embodiment, the information interchange system module 630 is coupled to the consumer preference database 620 as an add-on module.

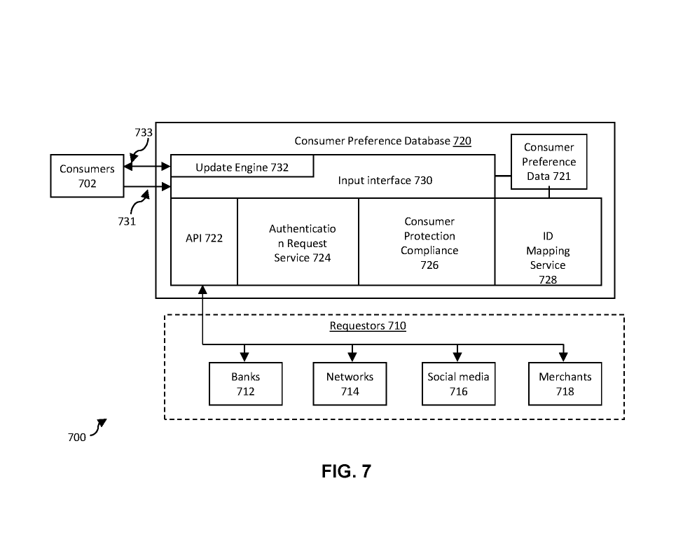

FIG. 7 depicts an alternative embodiment of a network 700 comprising consumers 702 and requestors 710 in communication with a consumer preference database 720 in which user consumer preference data 721 of the consumers 702 are stored. Banks 712, networks 714, social media sites 716, and merchants 718 deposit consumer preference data 721 into the consumer preference database 720 by accessing the consumer preference database 720 using the API 722 of the consumer preference database 720. In accordance to embodiments previously described, the consumer preference database 720 comprises an authentication request service module 724 and a consumer protection compliance module 726 to validate the request by any one or more requestors 710. The consumer preference database 720 further comprises a ID mapping service 728 which maps the consumer preference data 721 to a consumer preference representation (not shown), wherein the consumer preference representation is devoid of information that can be used to identify the customer. If the request is approved, the consumer preference representation is disseminated to the one or more requestors (i.e. recipients) 710. In an alternative embodiment, wherein the requestors 710 processes the consumer preference representation to recover the user preference data of the consumer, to regulate delivery of content to the consumer.

In the present embodiment, the consumer preference database 720 further comprises an input interface module 730 and an update engine 732. A consumer 702 inputs 731 consumer preference data 721 into the consumer preference database 720 using the input interface module 730. In an alternative embodiment, consumer preference data 721 of the consumer 702 that is stored in the consumer preference database 720 is automatically updated by an update engine 732 that is in communication 733 with the consumer 702. This provides an advantageous means of sustaining a relevant and up-to-date consumer preference database 720.

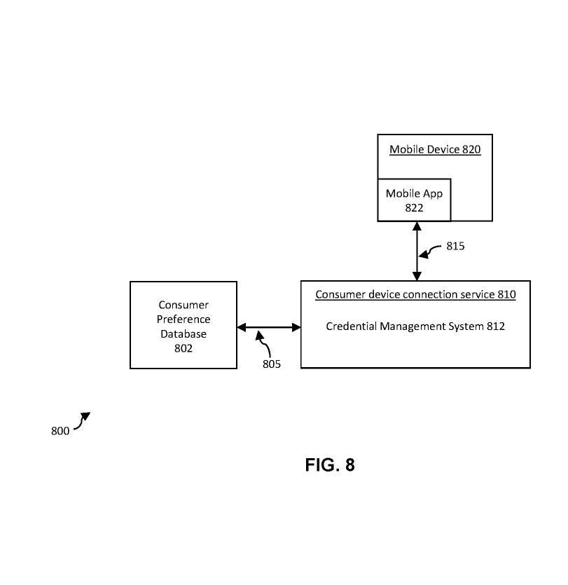

FIG. 8 depicts an embodiment exemplifying how consumer preference data (not shown) is transmitted to the consumer preference database 802 in a network 800. A mobile application 822 on the mobile device 820 of the consumer (not shown) is wirelessly connected 815 with a consumer device connection service module 810 in the network 800. The credential management system 812 in the consumer device connection service module 810 validates the credentials of the consumer (e.g. verifies the identity of the consumer). After the credentials of the consumer are validated, the consumer device connection service module 810 communicates 805 with the consumer preference database 802 to update the consumer preference data of the consumer, in accordance with preceding embodiments. This advantageously provides a convenient and secure means to update the consumer preference database 802 in an automatic and secure manner.

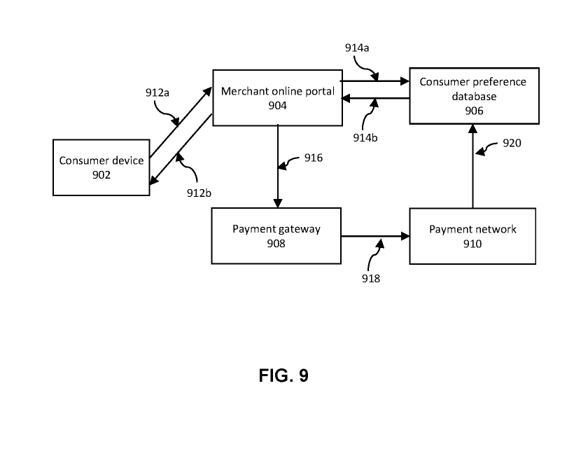

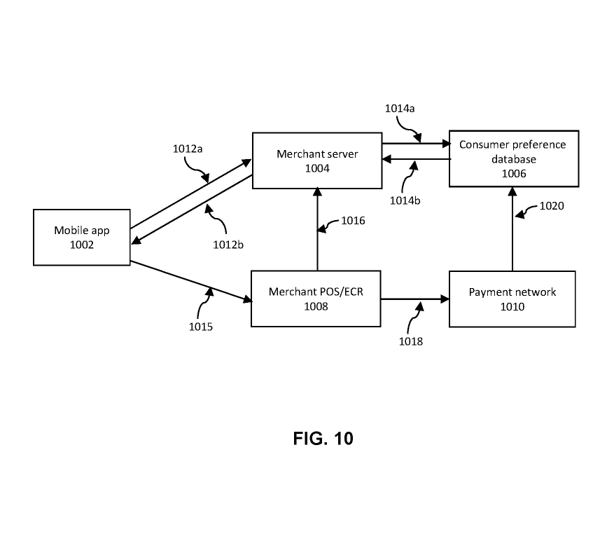

FIG. 9 depicts an embodiment exemplifying how consumer preference data is utilized during an online web transaction. In the embodiment, a consumer logs in using a consumer device 902, such as a personal computer, at the merchant's online portal. Authentication data is transmitted 912a from the consumer device 902 to the merchant online portal 904. The merchant online portal 904 sends a request 914a to the server with the consumer preference database 906 requesting information related to the consumer. The consumer preference database 906 authenticates the request 914a as described in above mentioned embodiments, and returns consumer preferences 914b of the user to the merchant online portal 904. The merchant online portal 904 pushes promotions 912b to the consumer's device 902 based on the user's preference retrieved from the consumer preference database 906. In the event that the consumer selects a promotion and makes a payment, the merchant online portal 904 sends the payment transaction data 916 to the payment gateway 908. The transaction data is then transmitted 918 to the payment network 910 where the transaction is processed for authorization. The transaction details are transmitted 920 to the consumer preference database 906 to update the user preference data. The merchant online portal 904 transmits 914a consumer redemption data (i.e. data related to promotions that the user purchased, or the coupon that the user redeemed) to the consumer preference database 906 to update the user preference data of the user. This transmission 914a of the consumer redemption data to the consumer preference database 906 may be done concurrently with the transmission 918 of the transaction data to the payment network 910.

Accordingly, a method is provided for presenting content to a user during an online web transaction. In step 912a, user log-in data from a user 902 is received at a merchant online portal 904. In step 914a, user preference representation of the user is requested from a server having a consumer preference database 906 on which user preference data is stored. In step 914b, the user preference representation of the user is received at the merchant online portal 904. Subsequently, the user preference representation is processed at the merchant online portal 904 to recover user preference data of the user towards any one or more of promotions, purchases and payment. In step 912b, promotional content that is relevant to the user is delivered to the user in response to the user preference data of the user.

FIG. 10 depicts an embodiment exemplifying how consumer preference data is utilized during an in-store transaction. In the embodiment, a user (consumer) uses a mobile application 1002 to contact a merchant server 1004. The connection 1012a between the mobile app 1002 and the merchant server 1004 is wireless and may be any one or more of WIFI, BLE or NFC. The merchant server 1004 authenticates the connection with mobile application 1002 and generates an identification code to pair with the mobile application 1002 that the consumer is using. The merchant server 1004 contacts 1014a the consumer preference database 1006 to request consumer preference data of the user. The consumer preference database 1006 authenticates the request 1014a as described in above mentioned embodiments, and returns consumer preferences 1014b of the user to the merchant server 1004. The merchant server 1004 displays promotions to the user on the mobile application 1002 based on the user's preference retrieved from the consumer preference database 1006. The user selects promotions (e.g. coupons) that the user wishes to redeem via the mobile application 1002. Subsequently, the user selects a payment method (e.g. POS, electronic cash register (ECR), or cash payment) for a purchase and the relevant instrument (e.g. credit card, or debit card, which may be in a digital wallet). During payment, the consumer may redeem promotions relevant to the purchase via WIFI, BLE, NFC, or QR code as the consumer pays for the purchase at the merchant's POS or ECR 1008. The merchant POS or ECR 1008 sends the payment transaction data 1018 to the payment network 1010 to be processed for authorization. The transaction details are transmitted 1020 to the consumer preference database 1006 to update the user preference data. The merchant POS or ECR 1008 transmits 1016 consumer redemption data (i.e. data related to promotions that the user purchased, or the coupon that the user redeemed) to the merchant server 1004 and is subsequently forwarded 1014a to the consumer preference database 1006 to update the user preference data of the user. This transmission 1014a of the consumer redemption data to the consumer preference database 1006 may be done concurrently with the transmission 1018 of the transaction data to the payment network 1010.

Accordingly, a method is provided for presenting content to a user during an in-store transaction. In step 1012a, a connection between the mobile application 1002, stored on the user's device, and an in-store merchant server 1004 is established and authenticated. In step 1014a, user preference representation of the user is requested from a server having a consumer preference database 1006 on which user preference data is stored. In step 1014b, the user preference representation of the user is received at the in-store merchant server 1004. Subsequently, the user preference representation is processed at the in-store merchant server 1004 to recover user preference data of the user towards any one or more of promotions, purchases and payment. In step 1012b, promotional content that is relevant to the user is delivered to the user in response to the user preference data of the user.

Some portions of the foregoing description are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. A method or algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “determining”, “disseminating”, “configuring”, “providing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods mentioned above. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. In addition, the present specification also implicitly discloses a computer program, in that it would be apparent to the person skilled in the art that the individual steps of the methods described above may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the foregoing methods described.

Various embodiments of the invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

The use of the term ‘server’ herein may be understood to mean a single computing device or a plurality of interconnected computing devices which operate together to perform a particular function. That is, the server may be contained within a single hardware unit or be distributed among several or many different hardware units.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

What is claimed is:

1. A method for disseminating user preference data, the method comprising:
determining a user preference representation, wherein the user preference representation is configured to represent user preference data of a user towards any one or more of promotions, purchases and payment; and
disseminating the user preference representation to a plurality of recipients, wherein the plurality of recipients processes the user preference representation to recover the user preference data of the user, to regulate delivery of content to the user.

2. The method in accordance with claim 1, wherein the user preference data is derived from data related to the user.

3. The method in accordance with claim 2, wherein the data related to the user comprises any one or more of user privacy preferences, user transaction preferences, user content preferences and user security preferences.

4. The method in accordance with claim 3, wherein the user privacy preferences comprises user privacy settings, the user privacy settings comprising any one or more of online status, user location and notification frequency.

5. The method in accordance with claim 3, wherein the user transaction preferences comprises user transaction information, the user transaction information comprising any one or more of product purchase history, transaction amount, and frequency of transaction.

6. The method in accordance with claim 3, wherein the user content preferences comprises user content information, the user content information comprises any one or more of frequently accessed information, topics of interest, and content subscription.

7. The method in accordance with claim 3, wherein the user security preferences comprises user security settings, the user security settings comprises any one or more of transaction authentication, maximum transaction allowance, and merchant whitelist.

8. The method in accordance with claim 2, wherein the user preference data is database records or input by the user.

9. The method in accordance with claim 1, wherein the plurality of recipients comprises content delivery agents, the content delivery agents comprising any one or more of point of sale terminals, electronic cash registers, websites, merchant online portals, merchants, financial institutions, and government bodies.

10. The method in accordance with claim 1, wherein the user preference representation is a message comprising any one or more of numbers, text or symbols.

11. The method in accordance with claim 1, wherein the step of disseminating the user preference representation comprises:
providing the user preference representation to the user for approval before dissemination in a format providing descriptive detail about the user preference representation.

12. The method in accordance with claim 1, wherein the plurality of recipients regulates the delivery of content to the user by delivering content in compliance with the user preference data of the user.

13. A server for disseminating user preference data, the server comprising:
at least one processor; and
at least one memory including computer program code;
the at least one memory and the computer program code configured to, with the at least one processor, cause the server at least to:
determine a user preference representation in response to user preference data received by the server, wherein the user preference representation is configured to represent user preference data of a user towards any one or more of promotions, purchases and payment; and
disseminate the user preference representation to a plurality of recipients, wherein the plurality of recipients processes the user preference representation to recover the user preference data of the user, to regulate delivery of content to the user.

14. The server for disseminating user preference data of claim 13, wherein the plurality of recipients regulates the delivery of content to the user by delivering content in compliance with the user preference data of the user.

15. The server for disseminating user preference data of claim 13, wherein the plurality of recipients comprises content delivery agents, the content delivery agents comprising any one or more of websites, merchants, financial institutions and government bodies.

16. A computer readable storage medium having a computer program recorded therein, the program being executable by a computer apparatus to configure the computer apparatus at least to:
determine a user preference representation, wherein the user preference representation is configured to represent user preference data of a user towards any one or more of promotions, purchases and payment; and
disseminate the user preference representation to a plurality of recipients, wherein the plurality of recipients processes the user preference representation to recover the user preference data of the user, to regulate delivery of content to the user.

17. The computer readable storage medium in accordance with claim 16, wherein the user preference data is derived from data related to the user.

18. The computer readable storage medium in accordance with claim 17, wherein the data related to the user comprises any one or more of user privacy preferences, user transaction preferences, user content preferences and user security preferences.
